(19) United States
(12) Patent Application Publication
(10) Pub. No.: US 2002/0165816 A1
(43) Pub. Date: Nov. 7, 2002

(54) Method for stochastically modeling electricity prices

(76) Inventor: Graydon Lee Barz, San Bruno, CA (US)

Correspondence Address: Jeffrey R. Ambroziak, BACHMAN & LaPOINTE, P.C., Suite 1201, 900 Chapel Street, New Haven, CT, 06510-2802, US

(21) Appl. No.: 10/137,918

(22) Filed: May 2, 2002

Related U.S. Application Data
(60) Provisional application No. 60/288,031, filed on May 2, 2001.

(51) Int. Cl. G06F 17/60

(52) U.S. Cl. 705/37

(57) ABSTRACT

A method for simulating commodity prices comprising the steps of receiving an input comprising a primary time series, computing a related time series from the primary series, identifying a cyclical variation series comprising a plurality of cycles for the related time series, identifying at least one dominant cyclical variation component series from the cyclical variation series, computing a plurality of contribution time series each comprising a plurality of contributions from each of at least one dominant cyclical variation component series to the cyclical variation series, regressing each of the contribution time series to compute a residual time series and a regression function, computing a future value fit time series from each of the regression functions, computing a future value residual time series from each of the residual time series, constructing a simulated contribution time series comprising a plurality of simulated contributions from each of the future value fit time series and the future value residual time series, combining the dominant cyclical variation component series with the simulated contribution time series to produce a simulated related time series, and computing a simulated primary time series from the simulated related time series.

### CROSS-REFERENCE TO RELATED APPLICATION

This application claims the benefit of U.S. Provisional Application No. 60/288031, filed May 2, 2001.

### BACKGROUND OF THE INVENTION

(1) Field of the Invention

The present invention relates to a method for stochastically modeling commodity spot prices over time. More specifically, the present invention relates to a method for characterizing and predicting the probability density function of electricity spot prices over time by integrating economic fundamentals from the electricity industry with statistical models.

(2) Description of Related Art

Accompanying the competition brought about by the deregulation of electricity markets is a substantial increase in price risk faced by generators, wholesale power traders, and consumers. Management of these new risks is a high stakes endeavor in a multi-billion dollar industry whose importance is attested by the rapid growth of power trading markets throughout the world.

Since severe financial distress may result from unmanaged exposures to prices that deviate significantly from expectation, understanding and predicting the stochastic behavior of electricity spot prices and not just expected value over time is essential for managing these risks. As used herein, “stochastic behavior” refers to the probability density function over time, which includes both the expected value as well as the distribution around this value. Indeed, understanding and predicting the stochastic behavior of electricity spot prices is the most significant challenge and value in electricity price risk management as well as in the valuation of electricity generation assets, long-term electricity supply contracts, and financial derivatives on electricity prices.

With severe price spikes and cyclical fluctuations as well as annualized volatilities of over 1000%, electricity price risk management presents unique challenges and opportunities. Indeed, in comparison to other commodities, the behavior of electricity prices is more tightly bound to such underlying macroeconomic factors of generation and consumption due to electricity's non-storability, and this tight bond precipitates its unique price characteristics.

While the underlying macroeconomic factors of electricity are known within the industry, their relationship to electricity spot prices is opaque. As used herein, “spot price” refers to the price of electricity at (or near) the time of delivery while “future price” refers to a contractually agreed price to be paid for electricity delivered at a predetermined future time.

Consequently, most stochastic financial models of electricity spot prices have not attempted to incorporate any macroeconomic drivers, relying instead on more traditional approaches based solely upon spot and/or futures price data. Indeed, many of these stochastic financial approaches continue to rely on a “return on investment” perspective derived from the world of alternative investment opportunities such as equities and highly-traded and “costlessly” storable assets. In such cases, relations between prices at various times are determined by these alternative investment opportunities, which define a dynamic equilibrium pricing relationship. In particular, because such assets may be easily traded, any deviation in the risk and return characteristics of these assets from those of such alternative investment opportunities provides an opportunity for arbitrageurs, who will capitalize on such deviation until the equilibrium is restored. However, in the case of electricity, its non-storability makes the arbitrage pricing relationships assumed by such models irrelevant.

For a non-storable commodity, storage costs and convenience yields are not applicable. Consider, for example, FIG. 1, an illustration of electricity's unique behavior, which depicts a time-series of electricity prices revealing complex daily and weekly price patterns seen in the Californian Power Exchange (CalPX) day-ahead power market. Note, these daily and weekly price patterns exhibit predictable cyclical movements. If electricity were an equity or highly-traded, “costlessly” storable commodity, arbitrageurs would have long since exploited away these predictable patterns by buying electricity when its price was low and selling when its price was high in ever-increasing amounts until the price for buying and selling at these various times converged.

Similarly, non-financial stochastic models that do not assume this arbitrage relationship such as Ornstein-Uhlenbeck mean-reversion or mean-reversion with jumps and that also do not integrate fundamental characteristics of the underlying economics are also inadequate for modeling electricity spot prices. In particular, these models fail to adequately characterize the stochastic behavior of electricity spot prices as well as fail to provide the intuition necessary to accommodate alternative viewpoints regarding evolving of economic conditions.

Efforts to bypass the non-storability dilemma described above by modeling the price dynamics of futures contracts provide some limited advantages over spot price modeling. Because futures contracts are easily storable “paper” assets, their behavior more closely resembles that of equities. However, such efforts are only applicable for describing the evolving future price for a fixed delivery time. They do not provide a relationship between the futures prices at differing delivery times and are therefore of limited value. Additionally, underlying every futures contract is an implied spot price model and, like the spot price models heretofore discussed, typically this behavior is unrealistic. Last, because the predetermined delivery time of current electricity futures contracts are based upon monthly averages of on-peak prices, even a highly representative futures model would be only marginally useful for managing granular (e.g. hourly) intra-month price risk.

In contrast to such stochastic financial models, agent-based models may alternatively be used. As used herein, “agent-based models” refer to models that replicate regional market structures in detail, e.g. every power generation plant and transmission line in a region. These agent-based models are somewhat effective in characterizing spot-price expectations, however, their utility comes at a price in terms of construction, calibration, and complexity. Currently, the large lead-times required for the acquisition, incorporation, and processing of market information, their local applicability, and their long run-times make the use of agent-based models for distribution-analysis in the rapidly changing electricity markets impractical.

To better understand the difficulties associated with agent-based models, it is useful to review the structure and operation of an exemplary market such as the California market. In addition, such a review serves to emphasize the close link of the California power market to electricity supply and demand.

Like most electricity markets, California's electricity market consists of numerous interdependent sub-markets. The California Power Exchange (CalPX) itself operates both a day-ahead and day-of market. The Independent System Operator (ISO), whose primary responsibility is system reliability, operates other complementary markets: the Real-time Imbalance market, the Ancillary Services market, and the Transmission Congestion Management market.

At 7:00 a.m., participants in the CalPX day-ahead market submit portfolio bids to buy and sell energy for each hour of the subsequent day. Based upon these submitted bids, the CalPX determines the equilibrium unconstrained-market-clearing price (UMCP) and quantity for each hour. Next, the ISO evaluates the feasibility of the resulting supply obligations in conjunction with bilateral transactions and makes any necessary adjustments according to additional schedule adjustment bids. After finalizing the day-ahead CalPX market-transmission schedules, the ISO conducts its day-ahead Ancillary Services auction and congestion management.

On the delivery day itself, buyers and sellers may respond to changes in supply (e.g. unexpected power outages) and demand (e.g. responses to weather fluctuations) by adjusting their positions via the day-of CalPX market. Sellers may also adjust their ancillary-services positions by bidding into the ISOs day-of Ancillary Services market. Ten minutes prior to delivery, participants may submit bids to the ISO Imbalance Energy market to provide generation for maintaining real-time system-wide energy balance.

For the purposes of this example, attention is focused the discussion on the day-ahead market because it settles before the other markets and is the forum for the majority of trades, though subsequent markets are not ignored. In particular, the ISOs real-time price cap of $250/MWh is accounted for because it essentially bounds day-ahead prices. This real-time price cap structurally induces demand elasticity as day-ahead prices approach $250/MWh by encouraging electricity consumers to transfer their demand bids from the day-ahead market to the real-time market.

Given the non-storability of electricity and the day-ahead auctions for hourly power, it is not surprising that the complex and unique characteristics of electricity price behavior are strongly linked to the underlying microeconomics. In particular the non-storability and hourly markets prevent using “inventory” or “averaging,” respectively, to smooth-out even minor fluctuations in the real-time balance between production and consumption. Instead, to be effective, models of the stochastic behavior of spot prices instead must reflect the predictable and unpredictable variations in this dynamic equilibrium.

It is therefore useful to understand the relationship between electricity price behavior and (1) the cyclical nature of electricity demand, (2) the nonlinear nature of the electricity supply-stack, and (3) the interaction of these two factors. Such an understanding illuminates much about electricity's price behavior.

First, examination of demand/supply data reveals cyclical patterns corresponding to seasonal effects (e.g. temperature) as well as daily and weekly lifestyle effects in addition to other less predictable fluctuations. Note, because of the nature of the electricity market, demand and supply are equivalent at each moment and the terms thus may be considered equivalent for the purposes of the present invention. With reference to FIG. 2, there is illustrated four weeks of time-series demand data with clear daily and weekly patterns. The fact that the frequency and direction of these demand fluctuations matches the observed price fluctuations of FIG. 1 suggests that demand fluctuations may be driving the price fluctuations. Note, however, while the demand fluctuations are relatively homoskedastic, the corresponding price fluctuations are not.

Second, an underlying supply stack is suggested in a scatter plot of price versus demand as illustrated in FIG. 3. As used herein, “supply stack” refers to a relationship between the amount of electricity demanded by (or, equivalently, supplied to) the market and the price per unit of this electricity: either expected price for a given level of demand the inverse of the expected supply at a given price. The increasing, generally convex, non-linear relationship between demand and the accompanying expected price suggests a supply-stack with a large percentage of inexpensive base-load power (with relatively constant prices over large portion of the low demand levels), a smaller percentage of moderately priced mid-merit generation assets (with more supply-sensitive prices over a higher demand range), and an even smaller amount of expensive peaking generation (with the most demand-sensitive prices at the highest levels of demand). This scatter plot also reveals that the heteroskedastic price volatility is in fact a generally increasing function of demand.

Third, examining the combined effect of demand fluctuations and the non-linear supply stack provides additional insight into the nature of electricity's price volatility as well as the origin of electricity's price spikes. Because the supply stack is generally convex, an increase in the demand shifts the marginal price to a steeper portion of the supply stack as illustrated by FIG. 4, which shows the price changes accompanying each of two 2000 MWh changes in demand. Consequently, the impact of demand fluctuations on price volatility depends on the general level of demand.

The increasing dispersion of prices at higher demand levels seen in FIG. 3 can be similarly explained. Because different generation assets have different levels of operational flexibility and may at any time be offline due to malfunctions or maintenance, the supply stack itself is slightly erratic. When demand is low, small changes in available supply (represented approximately by a left-right shift in the supply stack) have minimal impact on prices. However, when demand is high, the impact of equally small changes can be dramatic. As a result, the relationship between prices and demand is substantially more uncertain (i.e. volatile) during periods of high demand. The combined effect of demand fluctuations and an erratic, convex supply stack is thus highly dependent upon demand levels. A relatively predictable relationship with only moderate price fluctuations exists between low prices and low demand levels while a relatively unpredictable relationship exists between high prices and high demand levels with price-spikes generally corresponding to peaks in demand.

What is therefore needed is a method of modeling and predicting the stochastic behavior of electricity spot prices that (1) intuitively incorporates underlying economic fundamentals drivers of and observed cyclicality in the time-series of electricity spot prices, (2) does not rely upon inappropriate no-arbitrage relationships but instead characterizes the actual relationship between prices at various times, (3) provides a appropriately granular perspective (4) is simple enough to avoid large lead-times for the acquisition, incorporation, and processing of market information so as to be applicable for various regions and (5) does not rely upon unobservable inputs (e.g. the bidding strategies of market participants), inputs difficult to approximate, and/or complex inputs that can introduce significant model risk.

### SUMMARY OF THE INVENTION

Accordingly, it is an object of the present invention to provide a method for characterizing and predicting the probability density function of electricity spot prices over time by integrating economic fundamentals from the electricity industry with statistical models.

In accordance with the present invention, a method for simulating commodity prices comprises the steps of receiving an input comprising a primary time series, computing a related time series from the primary series, identifying a cyclical variation series comprising a plurality of cycles for the related time series, identifying at least one dominant cyclical variation component series from the cyclical variation series, computing a plurality of contribution time series each comprising a plurality of contributions from each of at least one dominant cyclical variation component series to the cyclical variation series, regressing each of the contribution time series to compute a residual time series and a regression function, computing a future value fit time series from each of the regression functions, computing a future value residual time series from each of the residual time series, constructing a simulated contribution time series comprising a plurality of simulated contributions from each of the future value fit time series and the future value residual time series, combining the dominant cyclical variation component series with the simulated contribution time series to produce a simulated related time series, and computing a simulated primary time series from the simulated related time series.

### BRIEF DESCRIPTION OF THE DRAWINGS

FIG. 1 A graph of hourly CalPX Day-Ahead Prices from Jul. 28, 1998 to Aug. 15, 1998.

FIG. 2 A graph of hourly CalPX Day-Ahead Demand from Oct. 18, 1998 to Nov. 15, 1998.

FIG. 3 A graph of hourly CalPX prices versus demand from Apr. 1, 1998 to Sep. 22, 1999.

FIG. 4 A graph illustrating an example of the supply stack impact on price and price volatility at various demand levels.

FIG. 5 A graph illustrating the primary time series data of hourly electricity spot prices versus the secondary time series data of electricity demand levels and the supply stack transform function derived according to the present invention.

FIG. 6 A graph illustrating a extension of the supply stack transform function derived according to the present invention.

FIG. 7 A graph of the synthetic demand time series derived according to the present invention.

FIG. 8 A graph of the three most dominant eigenvectors for the synthetic demand time series derived according to the present invention.

FIG. 9 A graph of each of the three contribution time series corresponding to the each of the three most dominant eigenvectors for the synthetic demand time series derived according to the present invention.

FIG. 10 A graph of each of the three predictable fits from the regression of the three contribution time series derived according to the present invention.

FIG. 11 A graph of each of the three simulated contribution time series derived according to the present invention.

FIG. 12 A graph of simulated primary time series of forecasted hourly electricity prices derived according to the present invention.

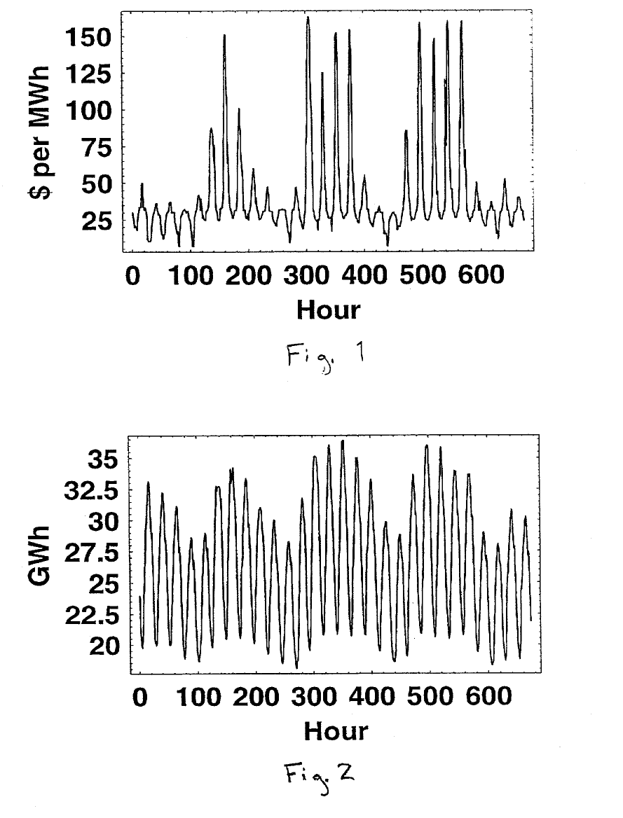

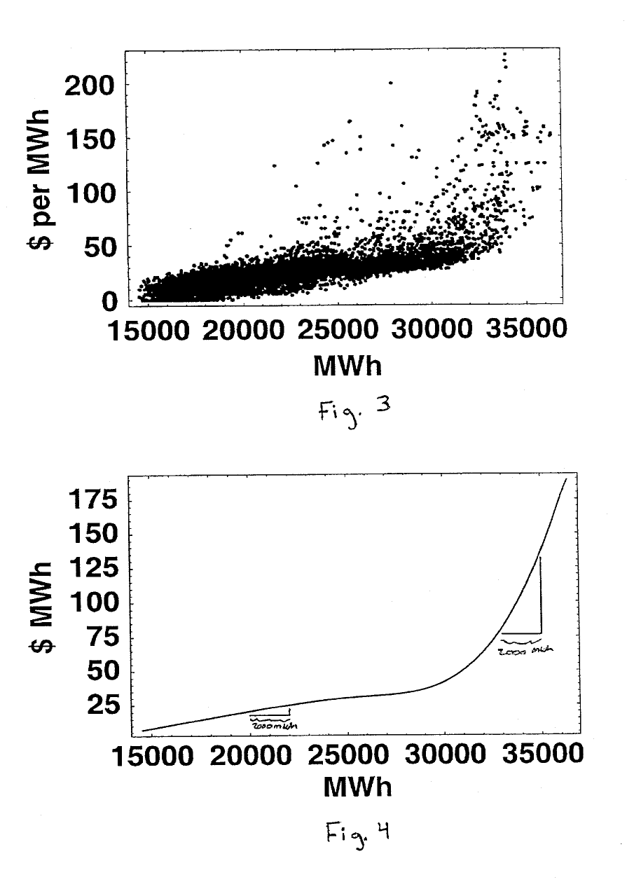

### DETAILED DESCRIPTION OF THE PREFERRED EMBODIMENT(S)

It is one aspect of the present invention to provide a method for modeling the values in a primary time-series that (1) intuitively incorporates underlying fundamentals drivers of and observed cyclicality in the primary time-series, (2) does not rely upon inappropriate no-arbitrage relationships but instead characterizes the actual relationships between values of a time-series at various times, (3) provides an appropriately granular perspective (4) is simple enough to avoid large lead-times for the acquisition, incorporation, and processing of necessary information so as to be broadly and/or narrowly applicable and (5) does not rely upon unobservable, difficult to determine, and/or complex inputs that can introduce significant model risk.

While described in the examples hereafter in regard to electricity spot prices, the present invention is not so limited. Rather it is broadly applicable to any good, service, or physical variable whose value is not governed by no-arbitrage relationships and upon which contingent claims may be based. For example: prices for bandwidth capacity, DRAM, electronic storage and/or processing, application service providers (ASP) services, spot electricity, agricultural products, energy commodities, chemical products and contracts and real-estate indices, weather indices, and other physical variables, and derivative contracts of any previously mentioned member of the group.

The method of the present invention may be expressed, generally, as consisting of eleven steps discussed in detail below: (1) receiving as inputs, primary time series, (2) computing a related time series from the primary time series, (3) identifying a cyclical variation series comprising a plurality of cycles for the related time series, (4) identifying at least one dominant cyclical variation component series from the cyclical variation series, (5) computing a plurality of contribution time series each comprising a plurality of contributions from each of at least one dominant cyclical variation component series to the cyclical variation series, (6) regressing each of the contribution time series to compute a residual time series and a regression function, (7) computing a future value fit time series from each of the regression functions, (8) computing a future value residual time series from each of the residual time series, (9) constructing a simulated contribution time series comprising simulated contributions from each of the future value fit series and the future value residual time series, (10) combining the dominant cyclical variation component series with the simulated contribution time series to produce a simulated related time series, and (11) computing a simulated primary time series from the simulated related time series.

It is a central feature of the method of the present invention to shift focus from a primary time-series obtained as an input, for example a time series of hourly electricity spot prices, to another related time-series, for example, a time series of hourly “synthetic” demand levels, so as to remove significant modeling complexity. In a preferred embodiment, this shift is done using a strictly monotonic transform function derived from a fundamental driver of the primary time-series. For example, in modeling electricity spot prices, we construct such a transform function by looking at the relationship between the primary time series of electricity prices and a secondary time series of observed demand levels. This transform function enables a shift of focus from the time series of electricity spot prices to a related time series of “synthetic” demand levels of electricity over time. Because demand fluctuations are homoskedastic versus heteroskedastic and do not exhibit the tremendous spikes seen in electricity prices, it is much easier to identify and predict cyclical patterns in demand than in price. Similarly, the adjustments necessary to incorporate the observed price-volatility relationships may be also introduced via such a transformation.

For example, an internet download is used to obtain the primary time-series of hourly CalPX electricity spot price data and the secondary time-series data of hourly CalPX electricity demand levels over a corresponding range of time. The strictly monotonic transform function that is computed is an approximation of a strictly increasing electricity supply-stack relating the time series of hourly CalPX electricity demand levels to the time series of hourly CalPX electricity spot prices for each corresponding time.

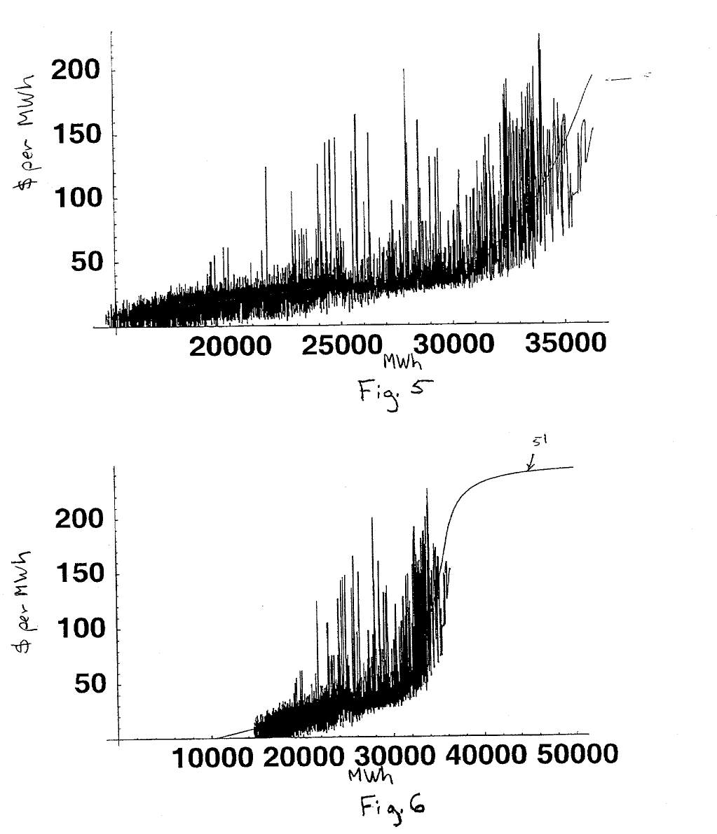

In a preferred embodiment, this supply stack transform function is computed by first determining the best least squares fit of electricity spot prices to electricity demand levels subject to the constraint that this best fit must exhibit an increasing fitted price for increasing demand levels. Once the fit is determined, the parameters of a strictly increasing cubic spline function representing the supply-stack transform function of actual demand to prices are fit to the demand and fit prices again using a least squares technique. With reference to FIG. 5, there is illustrated the resulting fit curve 51 to California market data. To extend the approximation of the supply-stack transform function over a broader range, the fit curve 51 is extrapolated so that it asymptotically approaches the induced price cap of $250/MWh with increasing demand levels as illustrated in FIG. 6.

Having constructed the supply stack transform function from demand to price, by inverting this supply stack transform to create an inverse supply-stack transform function, there is obtained a functional relationship between the time series of hourly electricity spot prices and a related time series, which, for the purposed of this example is called a time series of hourly “synthetic” demand since it roughly corresponds to electricity demand levels. Note, since the supply stack transform function is strictly monotonic, it is known to be invertible. To obtain the values of this related time series, the inverse supply-stack transform function is applied sequentially to each hourly value in the primary time-series of electricity prices. Thus, the time series of hourly synthetic demand is precisely determined. More significantly, using this artificial construct of synthetic demand in place of actual demand simplifies the model, essentially by combining actual demand and supply stack fluctuations into a single state variable. The synthetic demand time-series resulting from this process is illustrated in FIG. 7.

Having transformed the primary time series of hourly electricity spot prices into the related time series of hourly synthetic demand, we simplify the modeling of the related time series by reducing the complexity of cyclical fluctuations. This is accomplished by next identifying a cyclical variation series comprising of a plurality of cycles from the related time series. In the electricity example, the cyclical variation series is identified to be a series of cycles of twenty-four hourly values per day for each day in the synthetic demand time series, where each day's cycle of values corresponds to the deviation of synthetic demand level from the average synthetic demand level at each hour over the day. For example, given a series of 8760 hours over a year, the cyclical variation series is a series of 365 cycles, where each cycle consists of 24 hourly values with the average value for that hour over the 365 cycles subtracted from each corresponding value.

Next, we then identify at least one dominant cyclical variation component series from the cyclical variation series. In a preferred embodiment, three dominant cyclical variation component series are identified as the three principle components (a.k.a. eigenvectors) corresponding to the three dominant eigenvalues that result from an application of principle component analysis to the matrix of second moments of the cyclical variation series. For example, we simplify the modeling of the cyclical variation series of daily cycles of hourly fluctuations in synthetic demand using principle component analysis to identify three eigenvectors corresponding to three daily variation components.

While the motivation for this step comes from the use of principal component analysis in interest-rate term structure models, this step differs from the interest rate approach in two important aspects. First, interest-rate modelers measure day-to-day interest rate changes while the method of the present invention measures electricity deviations from a long-term average. The rationale for this difference is that the daily patterns in electricity are largely predictable whereas the stochastic term-structure-of-interest-rates process is assumed, due to arbitrage arguments, to be a martingale after the appropriate discounting. By martingale, we mean that its expected value at any time in the future is equal to its present value, so that no predictable pattern exists. Second, predictable components are incorporated into the deviations themselves since such deviations may also follow weekly and seasonal demand cycles.

Specifically, using principle component analysis, the dominant three “directions” of daily synthetic demand deviations are identified and used to reduce the dimensionality of these daily synthetic demand cycles from the observed 24 hourly values to the three contribution time series derived from the three eigenvector components. However, alternative embodiments may use from one to all of the eigenvectors, depending on the desired level of fidelity and accompanying complexity.

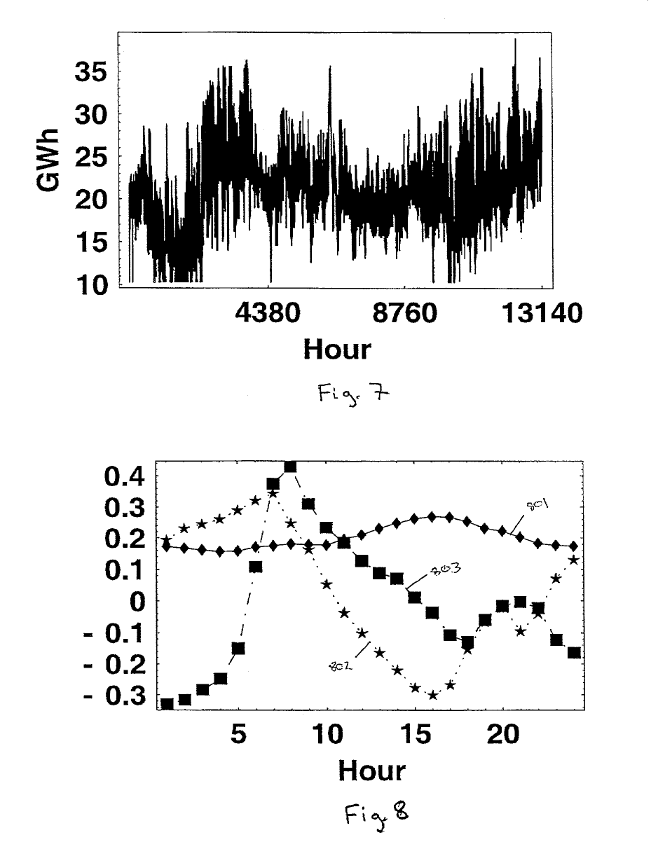

With reference to FIG. 8, there is illustrated the three dominant eigenvectors corresponding to the three most dominant eigenvalues, respectively, of the daily cyclical variation series for the synthetic demand series. The most dominant eigenvector 801, roughly corresponds to daily shifts in the overall demand level. The second eigenvector 802, deviates the most from zero during peak hours and approximately characterizes shifts in the location of midday peaks. The remaining principle component (i.e. third eigenvector) 803 may be thought to coincide with changes in the magnitude of the initial daily ramp-up magnitude.

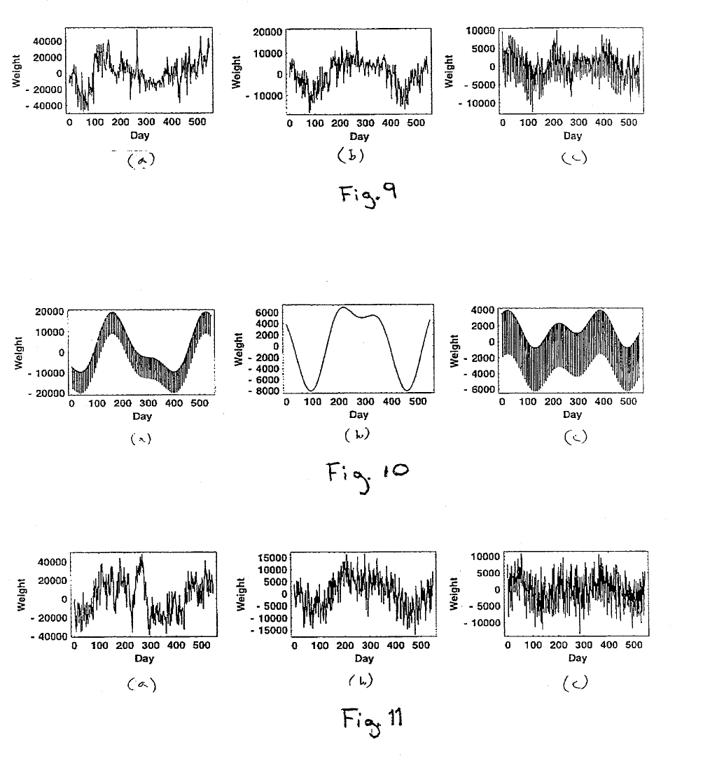

We next compute a plurality of contribution time series each comprising a plurality of contributions from each of at least one dominant cyclical variation component series to said cyclical variation series. For example, given the three aforementioned eigenvectors (i.e. domininant cyclical variation component series), we determine each of three contribution time series constructed by fitting of each of the three eigenvectors to each daily cycle of the cyclical variation series. In a preferred embodiment, we determine each contribution of each of the three contribution time series by fitting a linear combination of the dominant cyclical variation component series sequentially to each daily cycle in the cyclical variation series, where the fit is determined either via least squares or Kalman filtering. While illustrated with respect to least squares, the present invention is broadly drawn to encompass any statistical methodology for fitting one variable to one or more other variables. With reference to FIGS. 9(a-c), there is illustrated the three contribution time series (corresponding to the most dominant (a), second most dominant (b), and third most dominant (c) eigenvectors, respectively) discussed above.

Some observable predictability in these three graphs (FIGS. 9(a-c)) suggests the presence of both weekly and annual cyclical patterns as well as stochastic components.

To identify these weekly and annual cyclical patterns, each of the contribution time-series is regressed on day-of-week and seasonal variables to compute a fit time series, a residual time series, and a regression function. FIG. 10(a-c) shows the resulting predictable fit time series for each contribution time series. While illustrated with respect to regressions on day-of-week and seasonal variables, the present invention is broadly drawn to encompass other regressions with the components of the contribution time series as dependent variables.

In a preferred embodiment, to compute each of the future value fit series, the day-of-week and seasonal values corresponding to the desired future value fit series are input into the respective regression function.

In a preferred embodiment, to compute the future value residual time series from each of the residual time series, the three corresponding residual time series from each these regressions are modeled as Ornstein-Uhlenbeck (OU) stochastic processes. However, the present invention is more broadly drawn to encompass computing the future value residual time series using alternative stochastic processes. Each stochastic process modeling a residual time series is then simulated to construct a future value residual time series. Note, in the case of this example, the time periods are days.

In a preferred embodiment, the supply stack transform function, the regression functions of the predictable weekly and annual cyclical patterns, and the stochastic functions of residuals time series corresponding to each of the three time-series of weights may be updated to reflect modified predictive conditions. For example, (a) the supply-stack, which reflects the price at a given level of demand, may be modified reflect the expected addition of a new, base-load power plant, or changing characteristics of power generators such as more rapid power-up or power-down capabilities or, (b) the predictable component of the time-series of weights corresponding to the first eigenvector of synthetic demand may be adjusted to account for expected increases in actual electricity demand, or (c) in markets with large hydro components or changing population or economic levels, each predictive component as well as stochastic process of residuals may be modified to incorporate the dependence of supply on seasonal rainfall and reservoir levels.

Once any desired modifications have been made, each future value residual time-series is then combined with the corresponding future value fit time series to construct a simulated contribution time series comprising simulated contributions. In the case of this example, the combination is accomplished by adding the future value fit time series with the corresponding future value residual time series.

With reference to FIG. 11(a-c), there is illustrated three simulated contribution time series corresponding to the contribution time series associated with eigenvectors one to three respectively, for comparison with the contribution time series in FIG. 10(a-c). Though differing, rough similarities between the corresponding time series can be seen.

The dominant cyclical variation component series and the respective simulated contribution time series are then combined to produce a simulated related time series. For example, the simulated components of each simulated contribution time series (i.e. simulated daily weights of a dominant eigenvector) are multiplied by their corresponding eigenvector to generate a value for each period of the cycle (i.e. hour of the day) corresponding to each component of variation. The resulting values for each hourly period of the daily cycle and each day corresponding to each component of variation are then added together sequentially to generate a simulated synthetic demand.

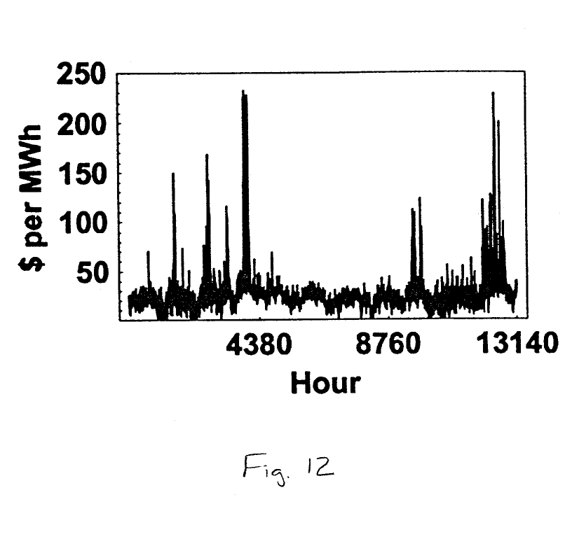

Last, a simulated primary time series is computed from the simulated related time series. For example, in a preferred embodiment consists of applying a supply stack transform function to the simulated synthetic demand will generate a simulated time series of electricity spot prices into the future. FIG. 12 illustrates a graph of a simulated primary time series.

The resultant simulated time series of electricity spot prices produced by the method of the present invention can be used to determine a distribution of values of financial derivatives of electricity, a distribution of possible values of a power plant, the optimal operating procedures of a power plant subject to unit commitment constraints, and/or a distribution of value of a long-term power contract.

In an alternative embodiment, the primary time series may first be modified to an adjusted time-series to reflect the presence of other influential factors. For example, in markets with significant natural gas based generation assets, the time-series of electricity spot prices may first be adjusted to incorporate a dependence on natural gas prices.

It is apparent that there has been provided in accordance with the present invention a method for stochastically modeling commodity spot prices over time which fully satisfies the objects, means, and advantages set forth previously herein. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed is:

1. A method for simulating commodity prices comprising the steps of:
Receiving an input comprising a primary time series;
Computing a related time series from said primary series;
Identifying a cyclical variation series comprising a plurality of cycles for said related time series;
Identifying at least one dominant cyclical variation component series from said cyclical variation series;
Computing a plurality of contribution time series each comprising a plurality of contributions from each of at least one dominant cyclical variation component series to said cyclical variation series;
Regressing each of said contribution time series to compute a residual time series and a regression function;
Computing a future value fit time series from each of said regression functions;
Computing a future value residual time series from each of said residual time series;
Constructing a simulated contribution time series comprising a plurality of simulated contributions from each of said future value fit time series and said future value residual time series;
Combining said dominant cyclical variation component series with the simulated contribution time series to produce a simulated related time series; and
Computing a simulated primary time series from said simulated related time series.

2. The method of claim 1 wherein computing a related time series from said primary series comprises the additional steps of:
Constructing an inverse transform function of said primary time series; and
Applying said inverse transform function to said primary time series.

3. The method of claim 1 wherein computing a future value residual time series comprises the steps of:
Selecting a stochastic process;
Fitting said stochastic process to said residual time series to produce a plurality of fit parameters; and
Simulating said stochastic process with said fit parameters.

4. The method of claim 1 wherein computing a simulated primary time series from said simulated related time series comprises the steps of:
Constructing a transform function of said simulated related time series; and
Applying said transform function to said simulated related time series.

5. The method of claim 2 wherein said inverse transform function is strictly monotonic.

6. The method of claim 1 comprising the additional step of modifying a series selected from the group consisting of primary time series, related time series, cyclical variation series, dominant cyclical variation component series, contribution time series, fit time series, and residual time series.

7. The method of claim 1 wherein said contribution time series is regressed against a time variable selected from the group consisting of hour, day, week, month, season, and year.

8. The method of claim 1 wherein said commodity is selected from the group consisting of prices for bandwidth capacity, DRAM, electronic storage and/or processing, application service providers (ASP) services, spot electricity spot, future electricity, agricultural products, energy commodities, chemicals, and real-estate indices, weather indices, and other physical variables, and derivative contracts of any previously mentioned member of the above group.

9. The method of claim 2, wherein constructing an inverse transform function of said primary time series comprises the additional steps of:
Receiving an input comprising a secondary time series; and
Identifying a transform function from said primary time series to said secondary time series.

10. The method of claim 1, identifying at least one dominant cyclical variation component series from said cyclical variation series comprises the additional steps of:
Constructing a matrix of second moments from said cyclical variation series;
Computing a plurality of principle components of said matrix of second moments; and
Selecting each of said dominant cyclical variation component series from said plurality of principle components.

11. The method of claim 1, wherein regressing each of said contribution time series a residual time series and a regression function comprises the additional steps of:
Receiving an input comprising a supplemental time series; and
Regressing each of said contribution time series on said supplemental time series to produce a residual time series and a regression fit.
